(19) United States
(12) Patent Application Publication
(10) Pub. No.: US 2011/0171081 A1
(43) Pub. Date: Jul. 14, 2011

(54) CORROSION-INHIBITING DEVICE

(76) Inventor: Andrea Elaine Buchanan, Verwood (GB)

(21) Appl. No.: 13/053,379

(22) Filed: Mar. 22, 2011

Related U.S. Application Data
(63) Continuation-in-part of application No. 11/662,037, filed on Nov. 8, 2007, now Pat. No. 7,931,803.

(30) Foreign Application Priority Data
Sep. 6, 2004 (GB) 0419686.1

(51) Int. Cl. B01J 8/00

(52) U.S. Cl. 422/187

(57) ABSTRACT

A corrosion-inhibiting device includes a housing having an inlet and an outlet, and a corrosion-inhibiting material positioned within the housing downstream of the inlet. At least a portion of the corrosion-inhibiting material is released into a fluid stream flowing toward the outlet. The corrosion-inhibiting device also includes an impeller supported for rotation within the housing and an oxidation removal means movable in response to rotation of the impeller and engageable with the corrosion-inhibiting material to remove oxidation formed on the corrosion-inhibiting material.

### CROSS-REFERENCE TO RELATED APPLICATIONS

This application is a continuation-in-part of co-pending U.S. patent application Ser. No. 11/662,037 filed on Nov. 8, 2007, which is a national phase application under 35 U.S.C. §371 of International Patent Application No. PCT/GB05/03436 filed on Sep. 6, 2005, the entire contents of all of which are incorporated herein by reference.

### FIELD OF THE INVENTION

The present invention relates to a fluid filter, and more particularly to fluid filters including corrosion-inhibiting devices.

### BACKGROUND OF THE INVENTION

A fluid filter typically comprises a fluid inlet and a fluid outlet between which is provided a filter element which may comprise a mesh filter element for example. The pores in the mesh are sized to allow fluid flow through the pores, but to trap particles of undesirable material carried by the fluid.

The pores can become blocked with trapped particles over time and to avoid the costs and inconvenience of replacing the filter element, it has been proposed to clean the filter element in situ.

It has been proposed to clean the filter element by scraping or brushing the filter element but this does not always clean the filter pores properly.

A back flushing process has been proposed wherein, during a cleaning cycle, the flow of fluid through the filter is reversed so that the filtered fluid in the downstream part of the filter is pumped back through the filter element to try to dislodge the particles from the upstream side of the filter pores. However this reversal of fluid flow is typically required to last for at least twenty-five seconds during which time normal use of the filter, and therefore of the fluid being filtered, is interrupted. Such back flushing also typically requires a fluid pressure above that which can often be achieved.

Furthermore, the back flushing process can suffer from so called rat-holing wherein the particles from only some of the filter pores are cleared, resulting in all of the fluid flowing through those cleared pores rather than cleaning the remaining blocked filter pores.

### SUMMARY OF THE INVENTION

The present invention provides, in one aspect, a corrosion-inhibiting device including a housing having an inlet and an outlet, and a corrosion-inhibiting material positioned within the housing downstream of the inlet. At least a portion of the corrosion-inhibiting material is released into a fluid stream flowing toward the outlet. The corrosion-inhibiting device also includes an impeller supported for rotation within the housing and an oxidation removal means movable in response to rotation of the impeller and engageable with the corrosion-inhibiting material to remove oxidation formed on the corrosion-inhibiting material.

Other features and aspects of the invention will become apparent by consideration of the following detailed description and accompanying drawings.

### BRIEF DESCRIPTION OF THE DRAWINGS

FIG. 1 is a sectional side view of a filter showing the filter in a rest condition.

FIG. 2 is a plan view of the filter of FIG. 1 taken on line A-A of FIG. 1.

FIG. 3 is a sectional side view corresponding to FIG. 1 but showing the filter in another condition.

FIG. 4 is a sectional side view of a modified filter, or a corrosion-inhibiting device, in accordance with a first embodiment of the present invention.

FIG. 5 is a plan view of the filter of FIG. 4, taken on line B-B of FIG. 4.

FIG. 6 is a sectional side view of a further modified filter showing the filter in a rest condition.

FIG. 7 is a view corresponding to FIG. 6 but showing the filter in another condition.

FIG. 8 is a perspective view of a corrosion-inhibiting device in accordance with a second embodiment of the present invention.

FIG. 9 is a view from underneath the device of FIG. 8.

FIG. 10 is a view from above the device of FIGS. 8 and 9.

FIG. 11 is sectional side view of the device of FIGS. 8 to 10, taken on line A-A of FIG. 8.

FIG. 12 is sectional view from above the device of FIGS. 8 to 10, taken on line B-B of FIG. 8.

FIG. 13 is sectional view from below the device of FIGS. 8 to 10, taken on line C-C of FIG. 8.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

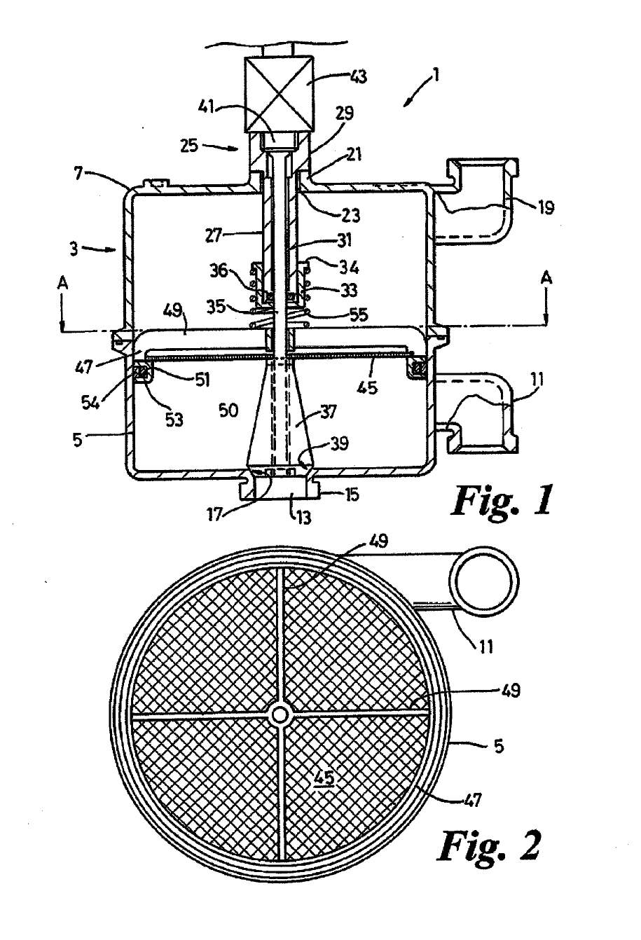

Referring to FIGS. 1 to 3, a fluid filter 1 comprises a hollow cylindrical housing 3 formed from two housing halves 5, 7 that are sealingly joined together using any suitable method which may include the use of a deformable gasket such as a rubber or fabric gasket. The housing halves 5, 7 could comprise peripheral, mating flanges that enable the housing halves 5, 7 to be bolted or clamped together, or the housing halves 5, 7 could comprise a peripheral, sealing snap fit type connection.

Lower housing half 5 comprises a radially directed tubular fluid inlet 11 which extends through the side wall of the lower housing half 5. Lower housing half 5 also comprises an axially aligned circular drain aperture 13 formed in a cylindrical boss 15 at the base of the lower housing half 5. The internal face of the boss 15 around the aperture 13 is chamfered 17.

Upper housing half 7 comprises a radially directed tubular fluid outlet 19 which extends through the side wall of the upper housing half 7. Upper housing half 7 also comprises an axially aligned cylindrical boss 21 formed with a short, threaded through bore 23.

An elongate guide hub 25 extends into the upper housing half 7 with the upper end of the body 27 of the hub 25 threadingly engaging the bore 23, and the underside of the head 29 of the hub 25 abutting the boss 21. The hub 25 is formed with an axial through bore 31.

An end cap 33 is secured to the lower end of the body 27 of the hub 25 and comprises a radially outwardly extending peripheral flange 34 that functions as a spring locator.

A shaft 35 extends through the bore 31 in the hub 25 such that the lower end of the shaft 35 projects through the end cap 33 and into the housing 3.

A seal 36 is provided at the lower end of the body 27 of the hub 25 which sealingly engages the shaft 35 to effect a fluid seal between the shaft 35 and the hub 25 to resist fluid leaking from the housing 3 and along the bore 31 in the body 27 of the hub 25. The seal 36 could comprise any suitable seal including, for example, an O-ring type seal. The seal may comprise an energizing O-ring type seal that pushes against a primary seal to force the primary seal into sealing contact with the hub 25.

The lower end of the shaft 35 terminates in a plug 37 that flares outwardly from the shaft 35. The wider, lower end of the plug 37 is radially inwardly chamfered 39 so as to seal with the chamfered face 17 of the boss 15 of the lower housing half 5 when the chamfered faces 17, 39 are in contact.

The upper end of the shaft 35 terminates in a piston 41 which is connected to actuation means comprising, in the example illustrated, a solenoid 43 operative to move the shaft 35 axially down within the bore 31 in the hub 25 against the biasing force of a spring 55 that acts to subsequently move the shaft 35 axially upwardly.

Filter means is also connected to the shaft 35 in between the end cap 33 and the plug 37. The filter means comprises a planar filter disc 45 comprising a mesh formed with a plurality of pores. The size of the pores will be selected so as to trap the desired particles from the fluid being filtered.

The periphery of the filter disc 45 is secured to reinforcing means comprising a circular outer ring 47 and two cross braces 49 arranged in cruciform when viewed in plan, see FIG. 2. The ring 47 and cross braces 49 are operative to resist deflection and deformation of the filter disc 45 in use, and in particular when some of the pores of the filter disc 45 become blocked as blocked pores will increase the force acting on the filter disc by the fluid flowing through the filter.

The filter disc 45 and reinforcing means are secured to the shaft 35 using, for example, a bolt 50 that extends up through the plug 37 and into a threaded bore (not shown) formed in the lower end of the shaft 35.

Sealing means are provided at the periphery of the reinforcing ring 47 to effect a fluid seal between the ring 47 and the side wall of the housing 3. In the example illustrated the sealing means comprises a peripheral groove 51 formed in the ring 47. An O-ring 53 sits in the groove 51 and acts against an outer sealing strip 54 also located in the groove 51. The O-ring 53 acts to push the outer sealing strip 54 into sealing engagement with the side wall of the housing 3.

Biasing means comprising a coil spring 55 is mounted on the shaft 35, the upper end of the spring 55 abutting the flange 34 of the end cap 33, and the lower end of the spring 55 abutting the cross braces 49 on the filter means. The spring 55 acts to bias the shaft 35 axially downwardly towards the base of the lower filter housing 5 and away from the solenoid 43 such that the drain plug 37 is biased into sealing engagement with the drain aperture 13. This rest position is shown in FIG. 1.

In use, with the filter in the rest position, fluid enters the fluid inlet 11 in the lower housing 5 and swirls around the lower housing 5. The fluid cannot drain through the drain aperture 13 because the plug 37 is biased to seal the drain aperture 13 as shown in FIG. 1. The fluid fills the lower housing half 5 and passes upwardly through the pores in the filter disc 45. Any particles in the fluid that are larger than the pores get trapped by the filter disc 45, whilst filtered fluid passes through the filter disc 45 and into the upper housing half 7. The filtered fluid exits the upper housing half 7 via the tubular outlet 19.

After a period of use, sufficient particles will be filtered from the fluid that some or all of the pores of the filter disc 45 become clogged or blocked. In such a situation, fluid flow through the filter 1 may be reduced or may stop altogether.

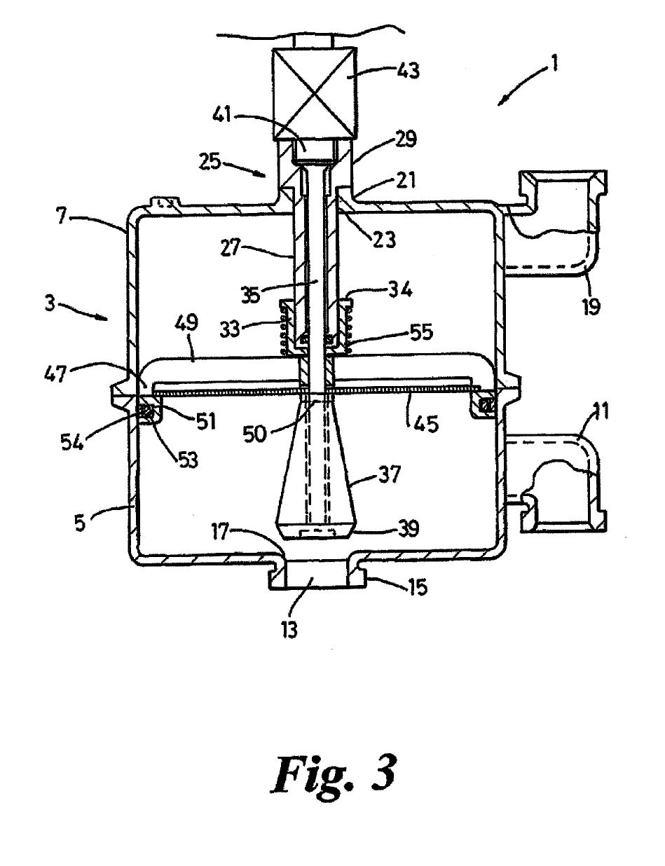

The filter 1 reverts to a cleaning cycle at a predetermined time which may correspond, for example, to the time at which a predetermined acceptable pressure drop or fluid flow rate occurs. During the cleaning cycle the solenoid 43 is actuated to pass a rapid pulse of tensile force to the shaft 35 to move the shaft 35, the filter disc 45 and the drain plug 37 axially upwardly towards the top of the upper filter half 7 and into the filtered fluid as shown in FIG. 3. This upward movement is against the biasing force of the spring 55. The pulse is preferably less than five seconds in duration but can be any duration suitable to dislodge the particles of filtered material from the blocked or clogged pores.

During this upward movement, fluid is still entering the housing 3 through the fluid inlet 11.

The pulse of upward movement serves to dislodge particles from clogged or blocked pores in the filter disc 45, the dislodged particles dispersing into the unfiltered fluid upstream (below) the filter disc 45. The continuing input of fluid through the fluid inlet 11 forces the fluid containing the dispersed particles along the path of least resistance, that is, through the open drain aperture 13.

The actuation means, namely the solenoid 43, thus serves to dislodge trapped particles from the filter disc 45, open the drain aperture 13, flush dislodged particles from the housing 3, and close the drain aperture 13 all using only a single, low energy pulse.

On termination of the pulse of force from the solenoid 43, the spring 55 biases the shaft 35, filter disc 45 and drain plug 37 downwardly away from the top of the housing 3 and the solenoid 43 to the rest position shown in FIG. 1 wherein the drain plug 37 sealingly closes the drain aperture 13.

The fluid can enter and exit the housing 3 under pressure provided from a pump or pumps (not shown), or under mains pressure as found in a water supply. It will be appreciated that the minimum pressure required to clean the filter is relatively low and is typically below the pressure typically achieved via a pump or mains fluid supply.

The inlet 11 and outlet 19 can be radially directed as described, or can be axially directed so as to be formed in the base and top of the lower and upper housing halves 5, 7 respectively. Having a radially directed inlet and outlet generates a spiraling of fluid within the housing 3 which improves filtration and improves the flushing of dislodged particles using the cleaning cycle described above.

The filter 1 can be a discrete unit, or could comprise one of a number of filters connected together in a filter system. The filters 1 could be connected together in series or in parallel, and the tubular inlet 11 and outlet 19 of each filter 1 can be shaped so as to facilitate alignment and connection between adjacent filters 1. The inlet 11 and outlet 19 comprise tubular elbows for example.

The connected filters 1, when connected in parallel, could comprise filter discs 45 of similar porosity so as to increase the volume of fluid filtered, or the connected filters 1, when connected in series, could comprise filter discs 45 of decreasing porosity in the direction of fluid flow so as to be able to filter finer material from the fluid.

The filter 1 or filter system could comprise part of any desired fluid system such as, for example, a domestic water supply, or an industrial fluid system such as a heating or cooling system.

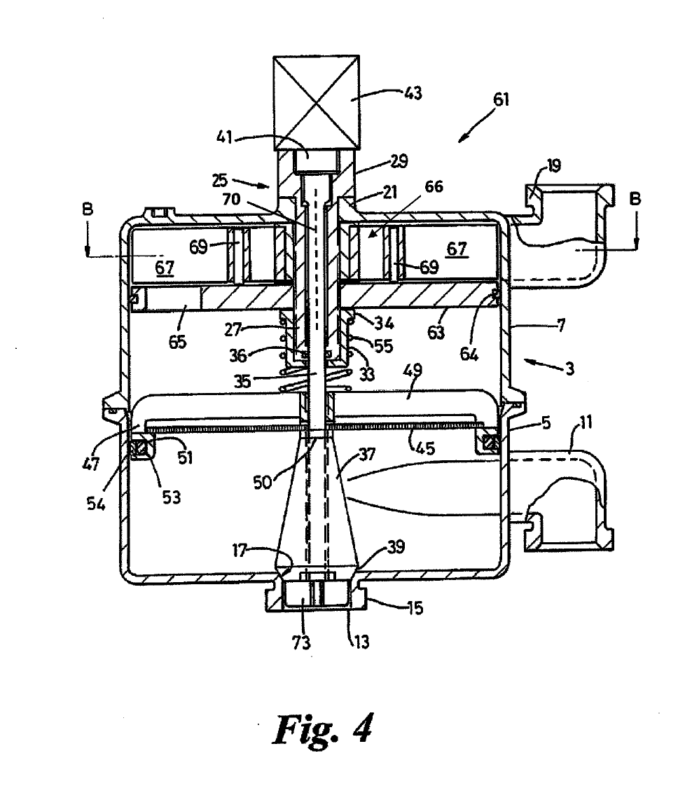

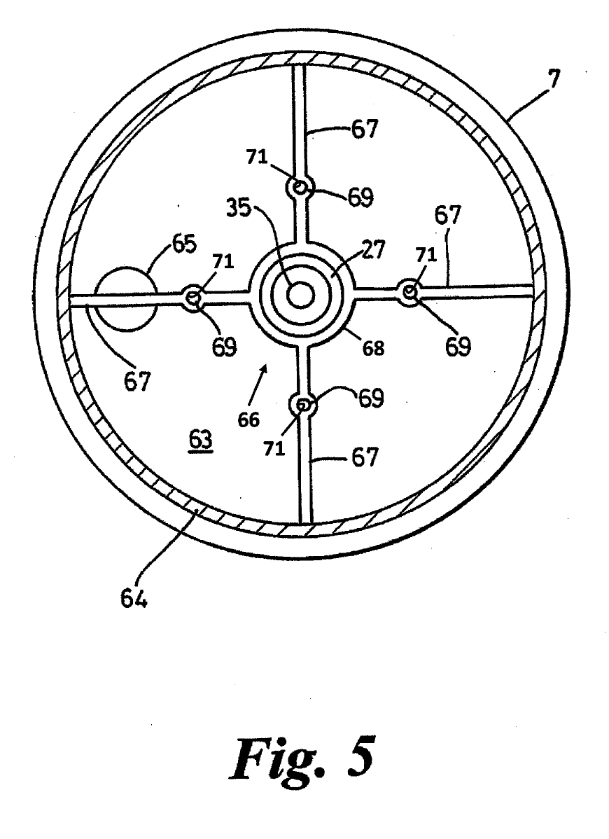

Referring additionally to FIGS. 4 and 5, a modified corrosion-inhibiting device or filter 61 is shown with like features being given like references.

Filter 61 additionally comprises an anti-corrosion means or a corrosion-inhibiting material configured as a disc 63 made from, or coated with, zinc. The disc 63 is mounted on the body 27 of the hub 25 above the spring 55. The periphery of the zinc disc 63 is provided with a suitable seal 64 that seals against an interior wall of the housing 3. The seal 64 may comprise an O-ring type seal. The disc 63 may be secured to the body 27 of the hub 25 in any suitable way including, for example, by screwing the zinc disc 63 onto threads formed on the body 27.

The zinc disc 63 and the seal 64 thus separate the downstream chamber of the upper filter half 7 into two sub chambers. These sub chambers are linked by an inlet aperture 65 formed in the zinc disc 63. As shown in FIG. 4, the inlet aperture 65 is located proximate one side of the housing 3, while the outlet 19 is located proximate an opposite side of the housing 3.

The corrosion-inhibiting device or filter 61 includes an impeller 66 having four equally spaced paddles 67 secured to a ring 68 that is rotatably mounted on the body 27 of the hub 25 above the zinc disc 63 in the upper sub chamber. As shown in FIG. 4, the impeller 66 is rotatable about an axis 70, with the zinc disc 63 being positioned coaxial with the impeller 66 on the axis 70. Each of the paddles 67 includes a distal end in close facing relationship with the interior wall of the housing 3, such that the diameter of the impeller 66 is substantially equal to that of the disc 63. The paddles 67 rotate under influence of the fluid entering the upper sub chamber through the inlet aperture 65. Each paddle 67 is provided with an anti-oxidation rod 69 that extends from top to bottom of the respective paddle 67. Any suitable number of paddles 67 and corresponding rods 69 can be provided.

In use the filtered fluid flows through the inlet aperture 65, into the upper sub chamber and into contact with the paddles 67 which rotate under influence of the filtered fluid such that the filtered fluid is swept over the zinc disc 63 and out through the tubular filter outlet 19. As the filtered fluid is swept over the zinc disc 63, particles of zinc are released into the filtered fluid stream. The zinc particles can assist in reducing corrosion of other components downstream of the filter 1.

The rods 69 are slidably mounted in bores 71 in respective paddles 67 and are under the influence of gravity such that the lower end of each rod 69 is in contact with the upper surface of the zinc disc 63. As the paddles 67 and rods 69 rotate, the lower surface of the rods 69 serves to abrade oxidation that may have formed on the upper surface of the zinc disc 63 thus maximizing the release of zinc particles into the filtered fluid stream.

The zinc disc 63 could be made from any other suitable material, such as aluminum or magnesium for example, that releases anti-corrosive particles into the filtered fluid stream. Likewise, the disc 63 may include a body having a zinc, aluminum, or magnesium coating that releases zinc, aluminum, or magnesium particles into the fluid stream as it flows toward the outlet 19. The rods 69 could also be made of any suitable material including, for example, brass, stainless steel or a ceramic material. Alternatively, one or more brushes may be substituted for the rods 69 and coupled to the paddles 67 for co-rotation with the paddles 67 to remove oxidation from the upper surface of the zinc disc 63.

The zinc disc 63 and paddles 67 thus serve to reduce the corrosive effects of any corrosive fluid that is being filtered.

The modified filter 61 also includes a shaft guide 73 that extends from the underside of the drain plug 37 into the drain aperture 13 so as to radially constrain the lower end of the shaft 35.

The solenoid 43 described above acts to pull the shaft 35 upwardly. However the filter 61 could be modified such the solenoid 43 is repositioned so as to push the shaft 35.

The solenoid 43 could be replaced with any other suitable actuation means operative to apply a pulse to the shaft 35 such as, for example, an electric motor such as a DC stepping motor, or a hydraulic or pneumatically operated piston. A rotating solenoid could be provided. A suitable gear mechanism can be provided if required.

Alternatively, it should be understood that the filter disc 45, the solenoid 43, the shaft 35, and any other component involved in reciprocating the filter disc 45 to dislodge filtered material from the disc 45 may be omitted from the embodiment of the corrosion-inhibiting device or filter 61 shown in FIG. 4, such that particles of corrosion-inhibiting material are released into an unfiltered fluid stream entering the housing 3 through the inlet 11.

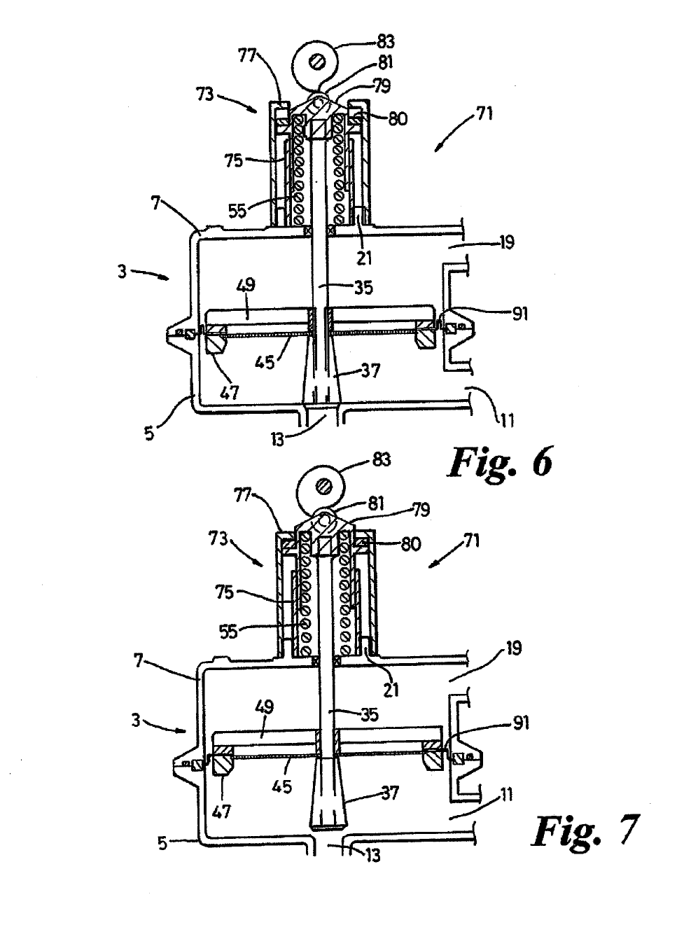

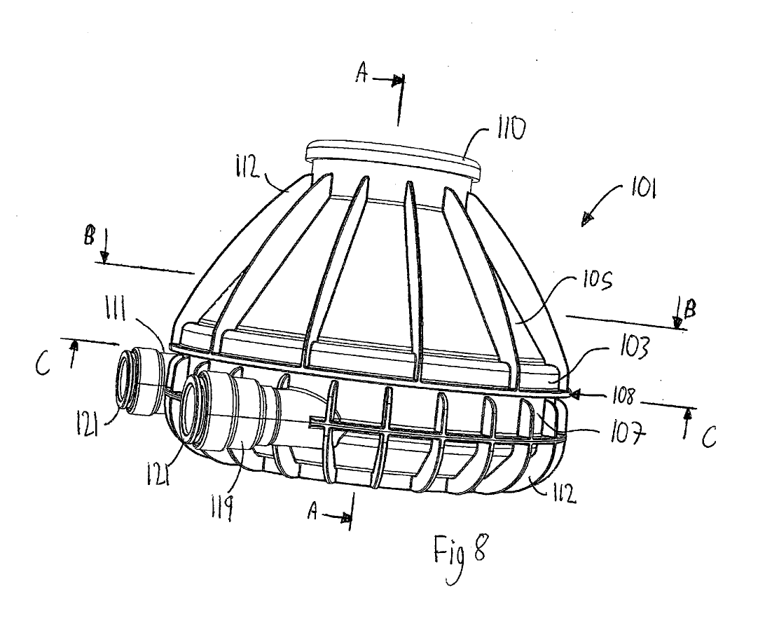

Referring to FIGS. 6 and 7 a modified filter 71 is shown comprising an alternative actuating mechanism. Like features have been given like references.

In this embodiment the filter 71 comprises an actuator assembly 73 that is mounted on top of the upper housing half 7 externally of the filter cavity.

The actuator assembly 73 comprises an inner tubular guide sleeve 75 the base of which threadingly engages the inside of the boss 21. An outer tubular actuator casing 77 surrounds the sleeve 75 with the lower portion of the casing 77 threadingly engaging the outside of the boss 21.

The upper end of the shaft 35 extends up through the sleeve 75 and is mounted to a movable spring locator 79 that can slide axially upwardly and downwardly along the guide sleeve 75 inside the housing 77. The coil spring 55 extends between the top of the housing half 7 and the underside of the spring locator 79. The upper surface of the spring locator 79 comprises a rubber end stop 80 that can engage the underside of the housing 77 and thus limits the maximum upward movement of the spring locator 79 and shaft 35.

The top of the spring locator 79 is provided with a cam follower 81 which in this example comprises a rotatably mounted wheel.

A cam 83 is mounted above the cam follower 81 and has a comma shaped profile, that is the diameter is constant for approximately 180 degrees, increases for approximately 170 degrees, and then reduces suddenly for approximately 10 degrees.

The cam 83 can be manually rotatable using a suitable hand crank for example (not shown) or could be electrically rotatable using a suitable electric motor (not shown).

The cam 83 rests in the position shown in FIG. 6 wherein the largest diameter portion of the cam 83 rests on the follower 81 which forces the spring locator 79, shaft 35, and plug 37 downwardly so that the plug 37 seals the drain aperture 13. When in this condition the filter 71 functions as described above with reference to filters 1 and 61.

When the filter 71 is to be cleaned, the cam 83 is rotated clockwise such that the narrowing diameter portion of the cam 83 is rotated into engagement with the cam follower 81. Because the diameter changes over a relative short rotational distance the follower 81 snaps upwardly under the influence of the spring 55. This causes the filter 45 to snap upwardly and causes the plug 37 to open the drain aperture 13 so that the cleaning cycle described above can occur.

An additional modification shown in the filter 71 of FIGS. 6 and 7 is the modified filter seal 91 wherein the energizing o-ring 53 and PTFE outer sealing strip 54 are replaced by a flexible seal 91 that extends between, and is secured to, the housing 3 and the filter 45. The seal 91 thus comprises the gasket that seals between the lower and upper housing halves 5, 7.

The flexible seal 91 has sufficient length that the seal 91 comprises a fold in the space between the filter 45 and the housing 3 when the filter 71 is in the rest position shown in FIG. 6.

When the filter 71 is undergoing the cleaning cycle shown in FIG. 7 the filter 45 has moved upwardly and this causes the fold in the flexible seal 91 to unfold to some extent to account for this difference in position.

The actuation means could be operated to apply the pulse to the shaft 35 via a control signal from a timer, or by a fluid pressure switch operate to send a control signal when the fluid pressure in the downstream chamber of the filter 1, 61, 71 falls below a predetermined level, or by a control signal from a manually operated device such as a push button switch.

Various seals are provided between the moving and static components of the above described filters 1 and 61. These seals could be any suitable seals such as O-ring type seals, or rubber or fiber gaskets for example.

The peripheral seal between the reinforcing ring 47 and the wall of the housing 3 preferably comprises an inner O-ring 53 that pushes against an outer PTFE sealing strip 55. However an O-ring alone may suffice.

In a modification of the described filters, a gasket could be provided between the upper and lower housing halves 5, 7, the gasket extending into the housing 3 and into sealing contact with the reinforcing ring 47 of the filter disc 45.

The housing 3 and filter disc 45 are described as being of circular cross section. However any other desired shape of cross section can alternatively be used.

The filter disc could be formed from any suitable material or combination of materials including, for example, a sintered metal material. The filter disc could comprise a laminate of filter elements of different pore size.

The shape of the housing 3 can be varied to suit the requirements of the filters 1, 61, 71. For example, the base of the lower filter half 5 can be tapered.

It will be appreciated that the various features described above with reference to filters 1, 61, 71 are interchangeable between filters 1, 61, 71

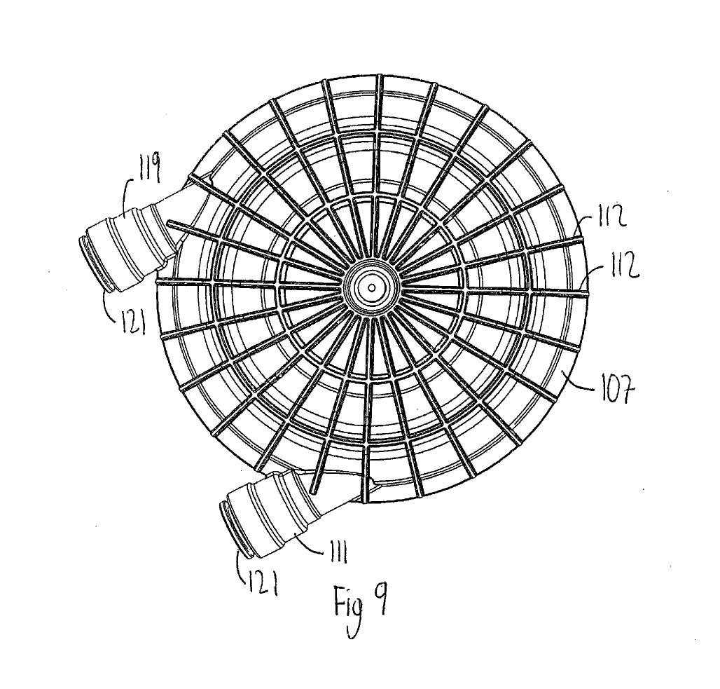

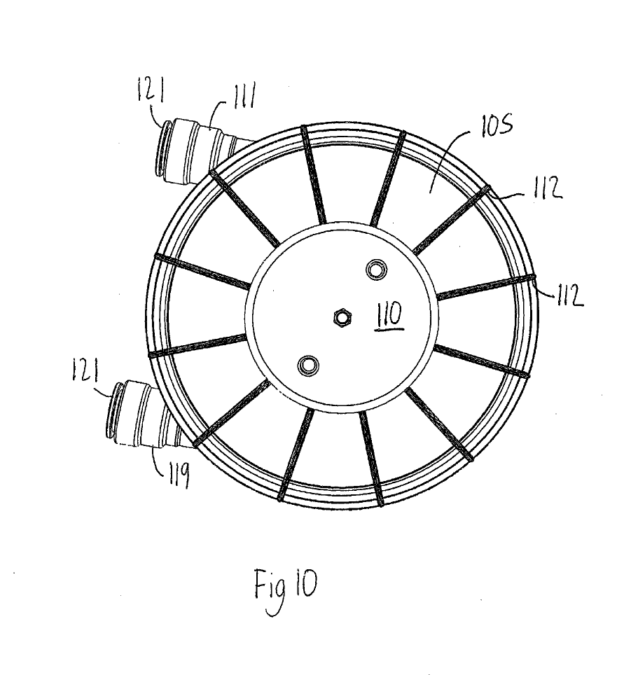

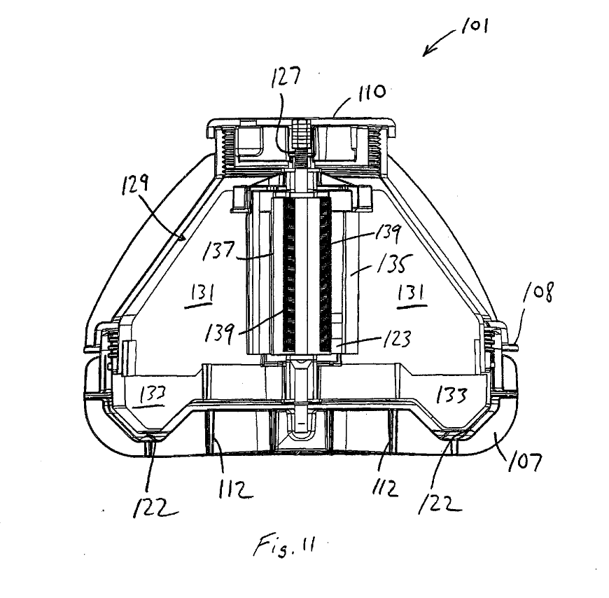

Referring now to FIGS. 8 to 10, a corrosion inhibiting device 101 comprises a hollow, circular transverse cross section housing 103 formed from upper and lower housing halves 105, 107 sealingly joined together at joint 108. Lower housing half 107 is provided with a tubular fluid inlet 111 and a tubular fluid outlet 119. Upper housing half 105 is generally conical in shape, the top of which terminates in a removable, screw-on end cap 110. Both housing halves 105, 107 are provided with external, spaced reinforcing ribs 112 to add strength to the housing 103. The tubular inlet 111 and outlet 119 are in this example provided with quickfit type pipe connectors 121 to enable a respective pipe to be quickly and sealingly fitted to the inlet 111 and outlet 119. In this example, the inlet 111 and outlet 119 both project from the same side of the housing 103.

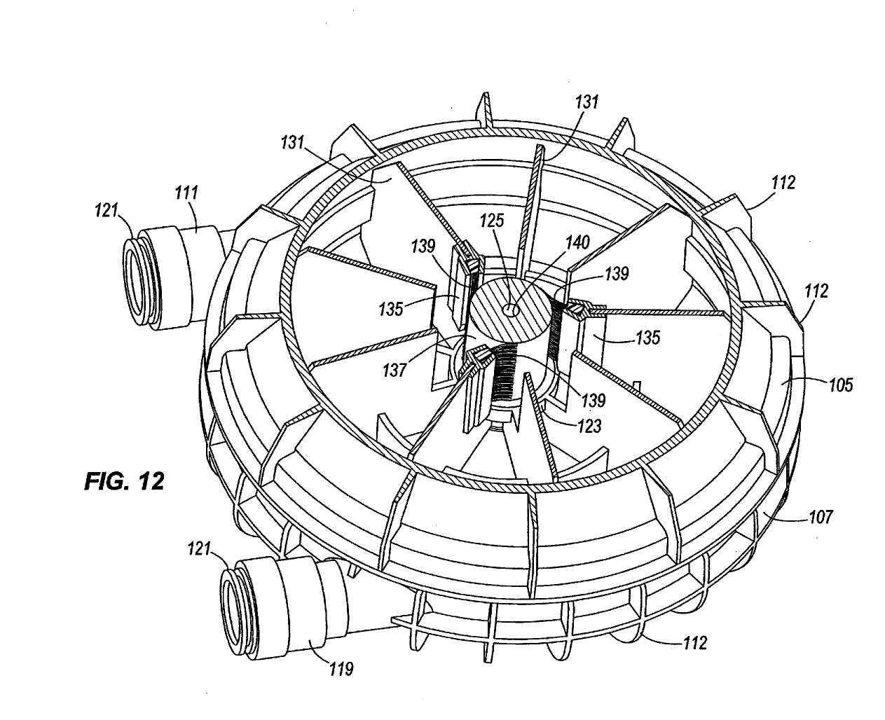

Referring additionally to FIGS. 11 to 13, a corrosion-inhibiting assembly is mounted within the housing 103 and is arranged such that fluid enters the device 101 through inlet 111, the fluid flowing in a generally circular path around the circumference of the interior of the housing 103, the fluid contacting the corrosion-inhibiting assembly before exiting the housing 103 through outlet 119.

The interior of the housing 103 is of generally conical shape as defined by the walls of the upper housing half 105. A circumferential trough 122 is defined at the base of the interior of the housing 103 that extends from the tubular inlet 111, around the base of the housing 103, to the tubular outlet 119.

The corrosion-inhibiting assembly comprises a central hub 123 rotatably mounted on a shaft 125 that extends from top to bottom of the housing 103. The upper end of the shaft 125 is mounted on a tubular bush 127 received in a bore on the underside of end cap 110. The lower end of the shaft 125 is mounted on a bush (not shown) on lower housing half 107.

An impeller 129 is mounted on the central hub 123 for rotation with the hub 123. The impeller 129 comprises a plurality of equispaced impeller paddles 131 each of generally triangular shape to correspond to the contour of the inside of the housing of the device 101. The impeller paddles 131 extend radially outwardly of the hub 123. The lower part of each paddle 131 includes a tab 133 that is received, and contours, the trough 122 in the lower housing half 107. The radially inner margin of each paddle 131 is received in a respective elongate slot 135, the slots 135 being equispaced around the hub 123.

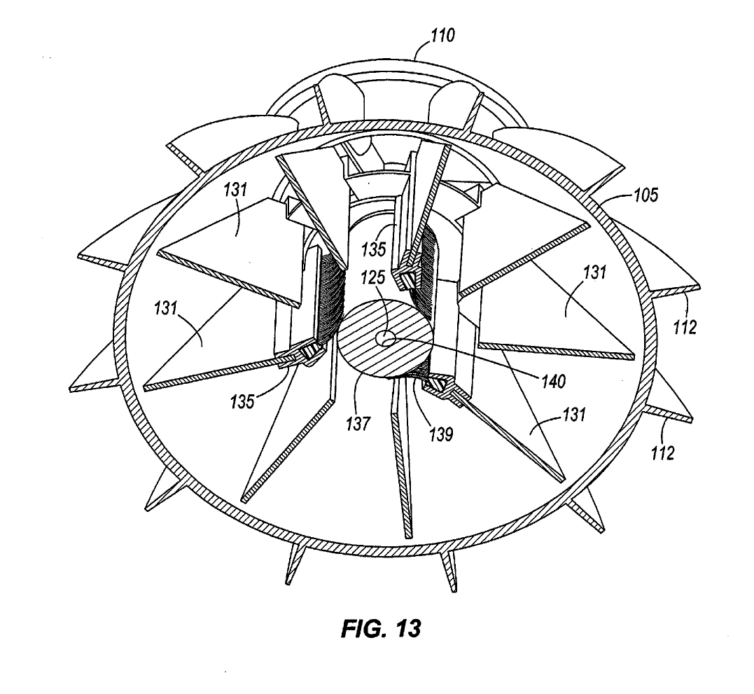

The corrosion-inhibiting assembly further comprises corrosion-inhibiting material arranged coaxially with the shaft 125, radially inwardly of the hub 123. In the illustrated embodiment of the device 101, the corrosion-inhibiting material comprises a cast zinc sleeve 137, the shaft 125 being received in a bore 140 extending through the sleeve 137 (FIGS. 12 and 13). The sleeve 137 is non-rotatably mounted on the shaft 125. In other words, the shaft 125 is mounted within the bore 140 and cannot rotate relative to the sleeve 137, the impeller 129 and the central hub 123 rotating about the shaft 125, and sleeve 137.

The corrosion-inhibiting assembly further comprises a plurality of oblong brushes 139 that are mounted on the hub 123 to project radially inwardly into contact with the zinc sleeve 137. Each brush 139 comprises an oblong of an abrasive material which may be a mesh type material, or a solid material formed with abrasive protrusions for example. Each brush 139 may be rigid, semi-rigid or flexible as required. The brushes 139 are mounted in this example on slotted brackets on the radially inner portion of each impeller 129. Each brush 139 can be slid out of the slot in its bracket for replacement or cleaning purposes. It is also envisaged that the brushes 139 could be mounted on fingers projecting from the hub 123 itself

In use, fluid enters the housing 103 via inlet 111, flows into trough 122, rises up the interior of the housing 103 and contacts the first impeller paddle 131. As the fluid pressure increases as more fluid enters the housing 103, the fluid exerts a driving force on the first impeller paddle 131 forcing the impeller 129 to rotate within housing 103 about shaft 125. The incoming fluid continues to drive rotation of the impeller 129 until the fluid exits the housing 103 via outlet 119.

As the fluid spins around the inside of the housing 103, it contacts the zinc sleeve 137 such that corrosion-inhibiting zinc particles are released into the fluid stream.

Rotation of the impeller 129 rotates the hub 123 and the oblong brushes 139 which brush against the stationary zinc sleeve 137. This contact between the brushes 139 and the sleeve 137 serves to abrade oxidation from the surface of the sleeve 137 to maximize the release of zinc particles into the filtered fluid stream.

Again, the zinc sleeve 137 can be alternatively formed from, or coated with, any suitable corrosion-inhibiting material to release corrosion-inhibiting particles into the fluid stream.

The zinc sleeve 137 is removable from the shaft 125 when the end cap 110 is unscrewed so as to be replaced or replenished as required.

Various features of the invention are set forth in the following claims.

What is claimed is:

1. A corrosion-inhibiting device comprising:
a housing including an inlet and an outlet;
a corrosion-inhibiting material positioned within the housing downstream of the inlet, at least a portion of the corrosion-inhibiting material being released into a fluid stream flowing toward the outlet;
an impeller supported for rotation within the housing; and
an oxidation removal means movable in response to rotation of the impeller and engageable with the corrosion-inhibiting material to remove oxidation formed on the corrosion-inhibiting material.

2. The corrosion-inhibiting device of claim 1, wherein the corrosion-inhibiting material is configured as a cylinder.

3. The corrosion-inhibiting device of claim 2, wherein the corrosion-inhibiting material is configured as a tubular sleeve arranged coaxially with the impeller.

4. The corrosion-inhibiting device of claim 1, wherein the corrosion-inhibiting material is removable from the housing.

5. The corrosion-inhibiting device of claim 1, wherein the oxidation removal means comprises at least one brush coupled for co-rotation with the impeller.

6. The corrosion-inhibiting device of claim 5 wherein the brush abrades oxidation formed on the corrosion-inhibiting material in response to rotation of the impeller.

7. The corrosion-inhibiting device of claim 1, wherein the oxidation removal means is mounted on a hub, the hub being supported for rotation within the housing coaxially with the impeller.

8. The corrosion-inhibiting device of claim 7, wherein the impeller is mounted on the hub, the impeller comprising a plurality of paddles extending radially outwardly from the hub.

9. The corrosion-inhibiting device of claim 1, wherein the impeller is rotatable about an axis, and wherein the corrosion-inhibiting material is positioned within the housing substantially coaxial with the axis.

10. The corrosion-inhibiting device of claim 1, wherein the corrosion-inhibiting material is configured as a disc, a seal being positioned between the disc and an interior wall of the housing, wherein the seal is engaged with the interior wall to fluidly separate the housing, in conjunction with the disc, into at least a first chamber and a second chamber.

11. The corrosion-inhibiting device of claim 10, wherein the disc includes an aperture fluidly communicating the first and second chambers of the housing.

12. The corrosion-inhibiting device of claim 10, wherein the inlet is positioned upstream of the disc and is in fluid communication with the first chamber, and wherein the outlet is positioned downstream of the disc and is in fluid communication with the second chamber.

13. The corrosion-inhibiting device of claim 1, wherein the impeller is rotated by the fluid stream flowing through the housing between the inlet and the outlet.

14. The corrosion-inhibiting device of claim 1, wherein the corrosion-inhibiting material includes at least one of zinc, aluminum, and magnesium.

15. The corrosion-inhibiting device of claim 1, wherein the corrosion-inhibiting material includes a body having at least one of a zinc coating, an aluminum coating, and a magnesium coating.

16. The corrosion-inhibiting device of claim 8, wherein each of the paddles includes a distal end in close facing relationship with an interior wall of the housing.

17. The corrosion-inhibiting device of claim 8, wherein the oxidation removal means includes a plurality of rods supported for co-rotation with the corresponding plurality of paddles.

18. The corrosion-inhibiting device of claim 1, wherein the oxidation removal means includes a rod slidably received within a bore in the impeller, wherein the rod is pulled toward the corrosion-inhibiting material under the influence of gravity to contact an upper surface of the corrosion-inhibiting material, and wherein the rod abrades oxidation formed on the corrosion-inhibiting material in response to rotation of the impeller.

19. The corrosion-inhibiting device of claim 1, further comprising a filter positioned between the inlet and the corrosion-inhibiting material.

20. The corrosion-inhibiting device of claim 19, further comprising a solenoid coupled to the filter, wherein the solenoid is operable to reciprocate the filter to dislodge particles of filtered material from pores in the filter.
